(19) United States
(12) Patent Application Publication
(10) Pub. No.: US 2014/0362028 A1
(43) Pub. Date: Dec. 11, 2014

(54) CAPACITIVE TOUCH SCREEN

(71) Applicant: FocalTech Systems, Ltd., Grand Cayman (KY)

(72) Inventors: Lianghua MO, Guangdong (CN); Chen LI, Guangdong (CN)

(73) Assignee: FocalTech Systems, Ltd., Grand Cayman (KY)

(21) Appl. No.: 14/080,967

(22) Filed: Nov. 15, 2013

(30) Foreign Application Priority Data
Jun. 6, 2013 (CN) 201310223781.6

(51) Int. Cl. G06F 3/044

(52) U.S. Cl. CPC G06F 3/044
USPC 345/174

(57) ABSTRACT

The embodiments of the invention disclose a capacitive touch screen, including: a substrate; a plurality of sensing electrodes provided on the substrate, the plurality of sensing electrodes being arranged in a two-dimensional array; and a touch control chip bound to the substrate, the touch control chip being connected with each of the plurality of sensing electrodes via a corresponding wire; the touch control chip being configured to detect a change of self-capacitance of each of the plurality of sensing electrodes by using a detection circuit with an adjustable precision, so as to determine touch information. The capacitive touch screen disclosed in the embodiments of the invention can achieve a true multi-touch and detect the touch positions of different touch objects accurately.

### CROSS REFERENCE TO RELATED APPLICATIONS

This application claims priority to Chinese patent application No. 201310223781.6 titled “Capacitive Touch Screen” and filed with the State Intellectual Property Office on Jun. 6, 2013, which is incorporated herein by reference in its entirety.

### BACKGROUND

1. Field of the Disclosure

The disclosure relates to the field of touch control technique, and particularly to a capacitive touch screen.

2. Background of the Technology

At present, the capacitive touch screen is widely applied to various electronic products, and has gradually penetrated into various fields of people's life and work. More and more capacitive touch screens begin to support a touch operation by a passive pen and a hand, however, the changes of mutual-capacitance caused by the touches of a passive pen and a hand are different, and the change of mutual-capacitance caused by the touch of a hand is relatively large, and generally the detection for the touch position of a hand is achieved by a mutual-capacitance principle; usually a passive pen can not cause enough change of mutual-capacitance due to a relatively small touch area. Therefore, the touch detection for a passive pen is generally achieved by a self-capacitance principle. However, when multiple passive pens are simultaneously used to perform a touch operation, usually the problem of ghost points may arise when the touch on the screen is detected with the self-capacitance principle. Therefore, the self-capacitive touch screen can not achieve a true multi-touch.

That is to say, the capacitive touch screen in the prior art is limited to the structure problem of the screen body, in which if the mutual-capacitance principle is used to detect a touch, then the touch position of a passive pen will not be accurately detected, while if the self-capacitance principle is used to detect a touch, then a true multi-touch will not be achieved. Thus, a new capacitive touch screen is necessary to be provided to solve the problem described above.

### SUMMARY

The embodiments of the invention provide a capacitive touch screen which can accurately detect the touch positions of a hand and a passive pen and achieve a multi-touch.

The capacitive touch screen provided by the embodiments of the invention includes:

a substrate;

a plurality of sensing electrodes provided on the substrate, the plurality of sensing electrodes being arranged in a two-dimensional array; and

a touch control chip bound to the substrate, the touch control chip being connected with each of the plurality of sensing electrodes via a corresponding wire, and the touch control chip being configured to detect a change of self-capacitance of each of the plurality of sensing electrodes by using a detection circuit with an adjustable precision, and thereby determine touch information.

Preferably, the detection circuit with an adjustable precision includes:

a voltage source or current source;

a capacitor to be detected, with one end of the capacitor to be detected being grounded, and the other end of the capacitor to be detected being connected with the voltage source or current source via a switch, wherein a capacitance value of the capacitor to be detected changes when there is a touch;

an adjustable capacitor, the adjustable capacitor being connected with a voltage source or current source at its two ends, wherein the precision is adjusted by changing the capacitance value of the adjustable capacitor; and

a measurement unit, the measurement unit being connected to the adjustable capacitor, and measuring the change of the self-capacitance of each of the plurality of sensing electrodes according to the precision.

Preferably, the voltage source or current source has a single frequency; or the voltage source or current source has two or more frequencies.

Preferably, the touch control chip detecting a change of self-capacitance of each of the plurality of sensing electrodes by using the detection circuit with an adjustable precision includes:

detecting the changes of the self-capacitances of the plurality of sensing electrodes simultaneously by using the detection circuit with an adjustable precision; or

detecting the changes of the self-capacitances of the plurality of sensing electrodes group by group using the detection circuit with an adjustable precision.

Preferably, the substrate is a glass substrate, and the touch control chip is bound to the substrate in a chip-on-glass way; or

the substrate is a flexible substrate, and the touch control chip is bound to the substrate in a chip-on-film way; or

the substrate is a printed circuit board, and the touch control chip is bound to the substrate in a chip-on-board way.

Preferably, the sensing electrode is in a shape of a rectangle, a diamond, a circle or an ellipse.

Preferably, the capacitive touch screen includes a plurality of touch control chips bound to the substrate, and each touch control chip is adapted to detect a corresponding part of the plurality of sensing electrodes.

Preferably, the clocks of the plurality of touch control chips are synchronous or asynchronous.

It can be seen from the above technical solution that, the embodiments of the invention have the following advantages.

In the capacitive touch screen disclosed in the embodiments of the invention, the touch control chip is connected with each of the sensing electrodes via a wire and is bound to the substrate, and the plurality of the sensing electrodes are arranged in a two-dimensional array and there is no physical connection between the sensing electrodes, thereby a true multi-touch can be achieved. Furthermore, by providing a detection circuit with an adjustable precision for the touch control chip to detect the change of self-capacitance of each the sensing electrode, the capacitive touch screen can be set with different precisions according to different touch objects, thereby achieving an accurate detection for the touch position.

### BRIEF DESCRIPTION OF THE DRAWINGS

FIG. 1 is a schematic diagram of a capacitive touch screen according to an embodiment of the invention;

FIG. 2 is a top view of a sensing electrode array according to an embodiment of the invention;

FIG. 3 is an operation circuit for sensing electrodes according to an embodiment of the invention;

FIGS. 4A to 4C are schematic diagrams of the scanning timing of sensing electrodes according to an embodiment of the invention;

FIG. 5 is a diagram of a touch detection circuit according to an embodiment of the invention;

FIG. 6 is a timing diagram of the touch detection circuit according to an embodiment of the invention; and

FIG. 7 is a flow chart of a touch detection method according to an embodiment of the invention.

### DETAILED DESCRIPTION

To make the objects, features and advantages of the disclosure more apparent and easy to be understood, the technical solutions of the embodiments of the disclosure are illustrated hereinafter in conjunction with the drawings in the embodiments of the disclosure. Apparently, the described embodiments are just a part of the embodiments of the invention. Based on the embodiments of the disclosure, any other embodiments obtained by those skilled in the art without creative efforts should fall within the scope of protection of the invention. For ease of illustration, sectional views showing the structure are enlarged partially rather than using a usual scale, and the views are only examples, which should not be understood as limiting the protection scope of the invention. Furthermore, in an actual manufacture process, three-dimensioned sizes, i.e. length, width and depth should be included.

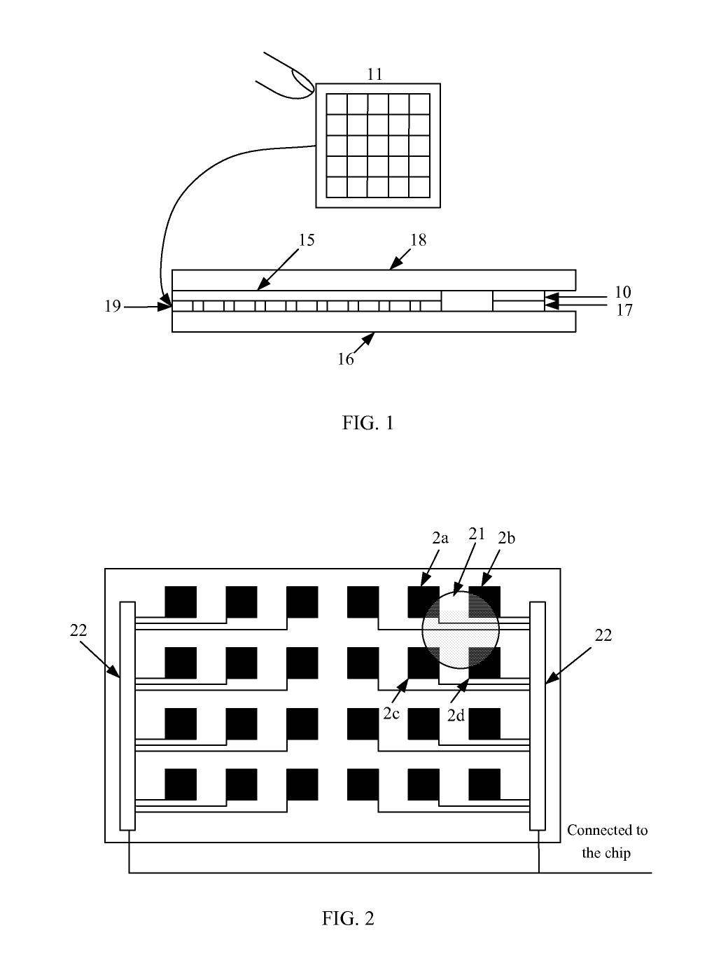

FIG. 1 is a schematic diagram of a capacitive touch screen provided by an embodiment of the disclosure. As shown in FIG. 1, the capacitive touch screen 11 includes: a substrate 16; a plurality of sensing electrodes 19 provided on the substrate, the plurality of sensing electrodes 19 being arranged in a two-dimensional array; and a touch control chip 10 bound to the substrate 16, the touch control chip 10 being connected with each sensing electrode 19 via a corresponding wire, wherein the touch control chip 10 is configured to detect a change of self-capacitance of each sensing electrode by using a detection circuit with an adjustable precision, and thereby determine touch information. The detection circuit will be illustrated hereinafter in detail.

The substrate 16 can be transparent, for example it may be a glass substrate or a flexible substrate; or the substrate 16 can also be non-transparent, for example it may be a printed circuit board. A plurality of sensing electrodes 19 are provided on the substrate 16, and the plurality of sensing electrodes 19 are arranged in a two-dimensional array which can be a rectangular array or a two-dimensional array in any other shapes. For the capacitive touch screen, each sensing electrode 19 is a capacitive sensor, the capacitance of which changes when a corresponding position on the touch screen is touched.

Optionally, a cover lens is provided above the sensing electrodes 19 to protect the sensing electrodes 19.

Each sensing electrode 19 is connected to the touch control chip 10 via a wire, and the touch control chip 10 is bound to the substrate 16. Due to being connected with each sensing electrode 19 via a wire, the touch control chip 10 has many pins; therefore, the difficulties of conventional packaging can be avoided by binding the touch control chip 10 on the substrate 16. Specifically, the touch control chip 10 can be bound to the substrate 16 in a Chip-on-Glass (COG for short) way or a Chip-on-Film (COF for short) way or a Chip-on-Board (COB for short) way. According to the embodiment, an anisotropic conductive film (ACF for short) 17 can be provided between the touch control chip 10 and the substrate 16.

Moreover, the connection of the conventional flexible printed circuit board (FPC) requires reserving spaces for the touch control chip and FPC in hardware, which is not beneficial to simplicity of the system. However, by the COG way or COF way, the touch control chip and the touch screen are integrated, thereby significantly reducing the distance between the two, and thereby reducing the whole volume. Moreover, since the sensing electrode is generally formed by etching indium tin oxide (ITO) on the substrate, and the touch control chip is also on the substrate, therefore, the line connecting the sensing electrode and the touch control chip can be done in one ITO etching process, thereby significantly simplifying the manufacturing process.

FIG. 2 is a top view of a sensing electrode array of an embodiment of the disclosure. Those skilled in the art should understand that, only one arrangement way of the sensing electrodes is shown in FIG. 2, however in specific implementation, the sensing electrodes can be arranged in any two-dimensional array. Moreover, the spacing between the sensing electrodes in any direction can be equal or not. Those skilled in the art should also understand that, the number of the sensing electrodes can be more than the number shown in FIG. 2.

Those skilled in the art should understand that, only one shape of the sensing electrode is shown in FIG. 2. According to other embodiments, the sensing electrode can be in a shape of a rectangle, a diamond, a circle or an ellipse, or can also be in an irregular shape. The pattern of the sensing electrodes can be identical or not. For example, the sensing electrodes located in the central area use a diamond structure, and the sensing electrodes located on edges use a triangle structure. Moreover, the sizes of the sensing electrodes can be identical or not. For example, the sizes of the sensing electrodes near the inside are relatively large, and the sizes of the sensing electrodes near the edges are relatively small, which is beneficial for routing and the touch precision of edges.

Each sensing electrode has a wire which is stretched out, and the wire is arranged in the space between the sensing electrodes. Generally, the wire is made as uniform as possible, and the routing is made as short as possible. Moreover, the routing range of the wires is made as narrow as possible on the premise of ensuring safe distance, thereby reserving more area for the sensing electrodes to enable more accurate sensing.

Each sensing electrode can be connected to a bus 22 via a wire, and the wires are connected directly with the pins of the touch control chip via the bus 22 or connected with the pins of the touch control chip via the bus 22 after being sorted. For the touch screen with a large screen, the number of the sensing electrodes may be very large. In this case, a single touch control chip can be used to control all the sensing electrodes; or the screen is divided into several regions, and a plurality of touch control chips are used to respectively control the sensing electrodes in different regions, and clock synchronization can be implemented between the plurality of touch control chips. At this time, the bus 22 can be divided into several bus sets for connecting with different touch control chips. Each touch control chip controls the same number of sensing electrodes, or controls a different number of sensing electrodes.

For the sensing electrode array shown in FIG. 2, the routing can be achieved in a same layer with the sensing electrode array. For the sensing electrode array having other structures, if routing in the same layer is difficult to achieve, the wire can also be arranged in another layer different from the layer where the sensing electrode array is located, and the wire is connected with the sensing electrodes via a via hole.

The sensing electrode array shown in FIG. 2 is based on a touch detection principle of self-capacitance. Each sensing electrode corresponds to a specific position on the screen. In FIG. 2, 2a-2d represents different sensing electrodes. 21 represents a touch, and when a touch occurs at a position corresponding to a certain sensing electrode, charge on this sensing electrode changes, thereby whether a touch event occurs on the sensing electrode can be known by detecting the charge (current or voltage) on this sensing electrode. Generally, this can be achieved by converting an analog quantity into a digital quantity by an Analog-to-Digital converter (ADC). The charge change amount of the sensing electrode is related to the covered area of the sensing electrode. For example, the charge change amounts of the sensing electrodes 2b and 2d are greater than the charge change amounts of the sensing electrodes 2a and 2c in FIG. 2.

Each position on the screen has a corresponding sensing electrode, and no physical connection exists between the sensing electrodes, therefore, the capacitive touch screen provided by the embodiments of the disclosure can achieve a true Multi-Touch, and thereby avoids the problem of ghost points in the self-capacitance detection in the prior art.

The sensing electrode layer can be combined with a display screen by a surface sticking way; or the sensing electrode layer can be manufactured inside the display screen, such as an In-Cell touch screen; or the sensing electrode layer can be manufactured on the upper surface of the display screen, such as an On-Cell touch screen.

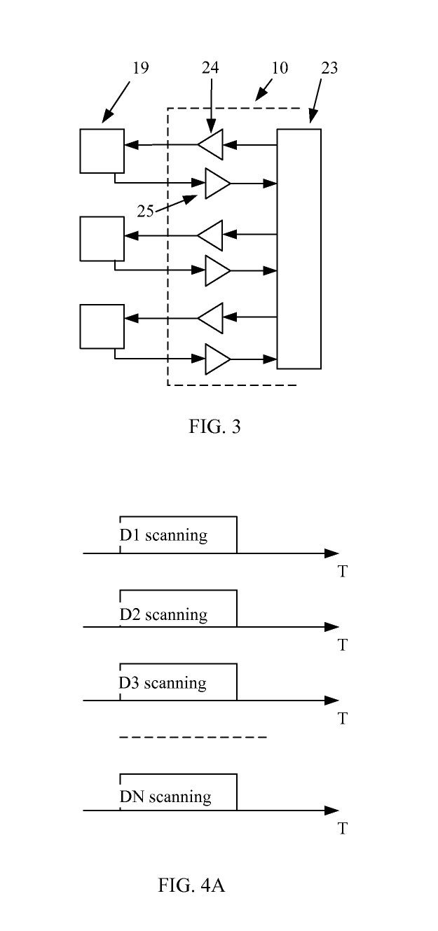

FIG. 3 is an operation circuit of the sensing electrodes according to an embodiment of the invention, the sensing electrode 19 is connected with both the driving source 24 and the detection circuit 25, and when the self-capacitance of the sensing electrode 19 changes, the change can be detected by the detection circuit 25. A sensing electrode 19 is driven by a driving source 24, and the driving source 24 may be a voltage source or a current source. For different sensing electrodes 19, the driving source 24 does not necessarily use the same structure. For example, the voltage source can be used for some of the sensing electrodes 19, and the current source is used for some of the sensing electrodes 19. Moreover, for different sensing electrodes 19, the frequency of the driving source 24 can be the same or different. The timing control unit 23 controls the operation timing of each driving source 24.

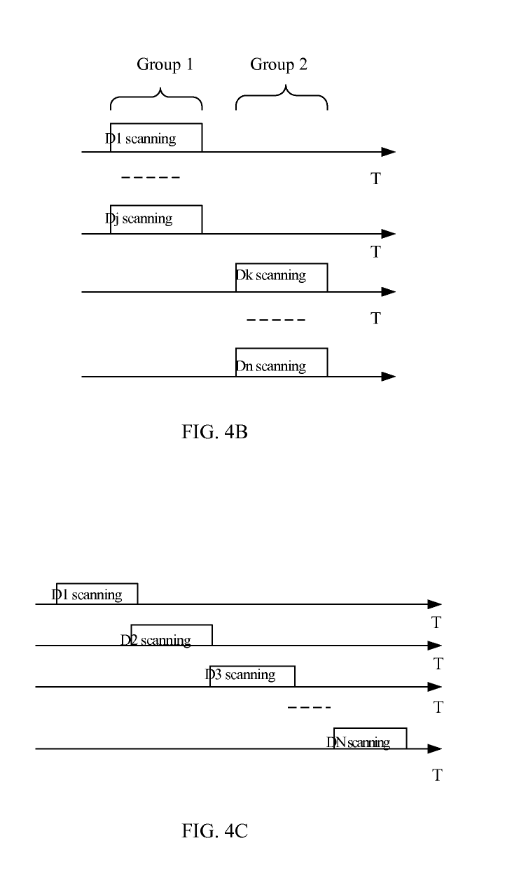

There are multiple choices for the driving timing of each sensing electrode 19. As shown in FIG. 4A, all the sensing electrodes are simultaneously driven and simultaneously detected. In this way, the time for finishing a scan is the shortest, and the number of the driving sources is the most (identical with the number of the sensing electrodes). As shown in FIG. 4B, the driving sources of the sensing electrodes are divided into several groups, and each group drives sensing electrodes in a specific region in sequence. This way can achieve multiplexing of the driving sources, but the scanning time is increased, however, by choosing a proper number of groups, the multiplexing of the driving sources and the scanning time can reach a compromise.

FIG. 4C shows a scanning way of conventional mutual-capacitance touch detection. Assumed that there are N driving channels (TX), and the scanning time for each TX is Ts, then the time for scanning one frame is N*Ts. However, by using the sensing electrode driving method of the embodiment, all the sensing electrodes can be detected simultaneously, the shortest time for scanning one frame is only Ts. That is to say, compared with the conventional mutual-capacitance touch detection, the scanning frequency can be increased by N times by using the scheme of the embodiment.

For a mutual-capacitance touch screen with 40 driving channels, if the scanning time for each driving channel is 500 us, the scanning time for the whole touch screen (one frame) is 20 ms, i.e. the frame rate is 50 Hz. Generally, 50 Hz can not achieve the requirements for a good experience. The scheme of the embodiments of the disclosure can solve this problem. By using the sensing electrodes arranged in a two-dimensional array, all the sensing electrodes can be detected simultaneously, and in the case that the detection time for each sensing electrode maintains 500 us, the frame rate reaches 2000 Hz. This greatly exceeds the application requirements of most touch screens. The redundant scan data can be used for such as anti-interference or touch track optimization by a digital signal processing terminal, thereby obtaining a better effect.

In-Cell touch screen performs scanning by using a field blanking time for each frame. However, the field blanking time for each frame is only 2-4 ms, and the conventional scanning time based on mutual-capacitance often reaches 5 ms or even more. In order to use the In-Cell screen, generally the scanning time for mutual-capacitance touch detection is reduced, specifically, the scanning time for each channel is reduced. This method reduces the SNR of the In-Cell screen, and affects the touch experience. The scheme of the embodiments of the disclosure can solve this problem. For example, for an In-Cell screen with 10 driving channels and a conventional mutual-capacitance detection scanning time of 4 ms, the scanning time for each channel is 400 us. By using the scheme of the embodiments of the disclosure, all the electrodes are simultaneously driven and detected, and the time for scanning all the electrodes once is only 400 us. Comparing with the In-Cell screen described above for which the scanning time for touch detection is 4 ms in total, there is a lot of time remained by using the solution of the present disclosure. The saved time can be used for multiple repeated detections or variable frequency detection and other detections, thereby greatly increasing the SNR of detection signal and anti-interference capability, and thereby obtaining a better detection effect.

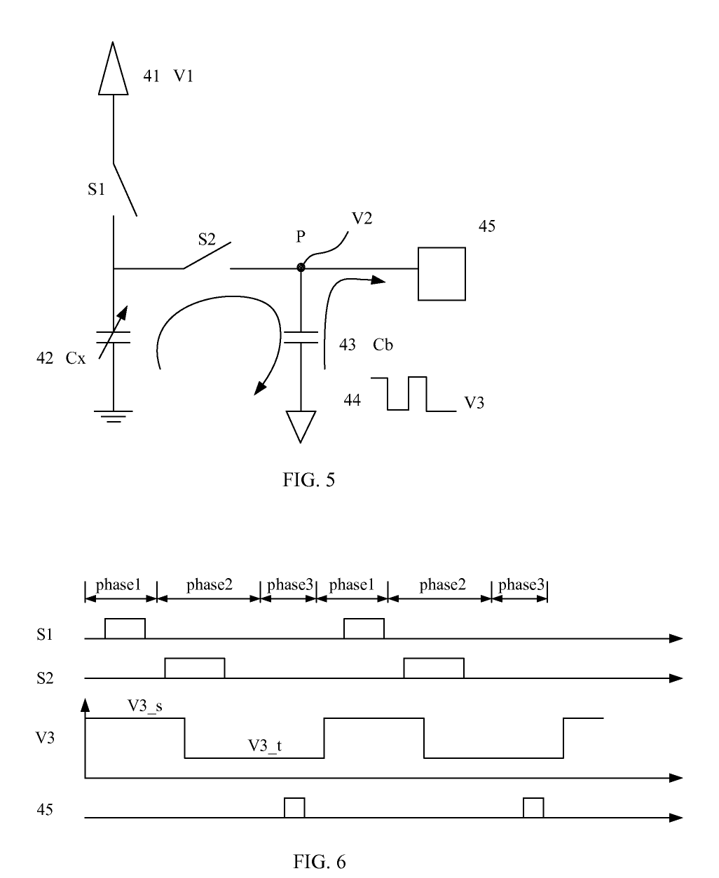

FIG. 5 is a diagram of a touch detection circuit according to an embodiment of the invention, and is also a detailed description for the detection circuit 25 in FIG. 3. Preferably, the self-capacitance of each sensing electrode is detected. The self-capacitance of the sensing electrode can be an earth capacitance thereof.

As an example, a charge detection method can be used. As shown in FIG. 5, the driving source 41 provides a constant voltage V1. The voltage V1 can be a positive voltage, a negative voltage or the earth. S1 and S2 represent two controlled switches, 42 represents an earth capacitor Cx of a sensing electrode. The value of Cx is fixed when there is no touch on the sensing electrode, however as soon as there is a touch on the sensing electrode, the value of Cx changes. 45 represents a measurement unit, and the measurement unit 45 can clamp the input voltage to a specified value V2, and convert the charges into a voltage by using a capacitor, then send the voltage to the ADC for measurement, in practice, i.e. the change of the earth capacitor Cx of the sensing electrodes is determined according to the change of the voltage measured by the measurement unit 45, thereby determining whether there is a touch on the sensing electrode and a specific touch position thereof 43 is a reference adjustment capacitor Cb with a known capacity and an adjustable value, one end of the Cb is connected to a voltage source V2, and the other end is connected to a voltage source V3, the value of V3 is variable. The function of Cb is to adjust a precision of the measurement unit 45. As another example, a current source can also be used, or the self-capacitance of the sensing electrode can be obtained by a frequency on the sensing electrode.

FIG. 6 is a timing diagram of a touch detection circuit according to an embodiment of the invention, the charge measurement process in FIG. 5 can be divided into several phases, and FIG. 6 shows several key steps. In FIG. 6, when S1 and S2 are at a high level, it indicates that the switches S1 and S2 are closed, and when S1 and S2 are at a low level, it indicates that the switches S1 and S2 are open. As shown in FIG. 6, the voltage source V3 may change between V3_{—}s and V3_{—}t. When the measurement unit 45 is at a high level, it indicates that the circuit is performing sampling and quantization, and when the measurement unit 45 is at a low level, it indicates that the circuit is on standby. In the following, the change of the charge quantity from the case that there is no touch on the sensing electrode to the case that there is a touch on the sensing electrode is illustrated in detail.

When there is no touch on the electrode, in phase 1, S1 is closed and S2 is open, V3 is in V3_{—}s status, and the upper plate of Cx is charged to a voltage V1 provided by the driving source 41. At this time:

the charge on Cx: Qx=Cx*V1

the charge on Cb: Qb=Cb*(V2−V3_{—}s)

the charge on an end of 45: Q45=0

in phase 2, S1 is open and S2 is closed, V3 changes from V3_{—}s to V3_{—}t status, and Cx exchanges charge with the measurement unit 45 and Cb, when in steady state:

the charge on Cx: Qx=Cx*V2

the charge on Cb: Qb=Cb*(V2−V3_{—}t)

since in the process from phase 1 to phase 2, there is a conservation of charge, therefore

Qx+Qb+Q45 in the two phases are equal, and the charge measured by the measurement unit 45 in the phase 2 can be obtained:

$$\begin{matrix}Q 45 = ( Cx * V 1 + Cb * ( V 2 - V 3 \_s ) ) - ( Cx * V 2 + Cb * ( V 2 - V 3 \_t ) ) \\ = Cx * ( V 1 - V 2 ) - Cb ( V 3 \_s - V 3 \_t )\end{matrix}$$

i.e., a voltage measured by the measurement unit 45 when there is no touch can be obtained:

V45=K*Q45=K*(Cx*(V1−V2)−Cb(V3_{—}s−V3_{—}t)) (1)

wherein K represents a gain, generally the charge is converted into a voltage by the capacitor in the circuit, K is a configurable value.

In the phase 3, still S1 is open and S2 is closed, the charge transfer between the nodes reaches a balance, and the measurement unit 45 begins to quantize the value of charge/voltage.

It can be seen from (1) that, after the Q45 is measured and quantified, there is only one variable Cx unknown, thus the original value of Cx can be obtained.

To ensure accuracy of data, the processes phase 1˜phase 3 can be repeated to obtain multiple measurement values of Cx, and then the multiple measurement values of Cx are averaged.

When there is a touch on the electrode, the value of Cx changes to Cx′. According to equation (1), the quantity of charge measured by the measurement unit 45 at this time is:

Q45′=Cx′*(V1−V2)−Cb(V3_{—}s−V3_{—}t)

i.e. when there is a touch, the voltage value measured by the measurement unit 45 is:

V45′=K*Q45′=K*(Cx′*(V1−V2)−Cb(V3_{—}s−V3_{—}t)) (2)

then the change of the voltage at the end of the measurement unit 45 caused by the touch when there is a touch on the sensing electrode is:

$$\begin{matrix}Δ V 45 = V {45}^{′} - V 45 \\ = K * ( Q {45}^{′} - Q 45 ) \\ = K ( {Cx}^{′} - Cx ) * ( V 1 - V 2 ) \\ = Δ Cx * K * ( V 1 - V 2 )\end{matrix} \qquad ( 3 )$$

It can be seen from the above equation that, the change ΔCx of the earth capacitor Cx of a sensing electrode can be obtained according to the change ΔV45 of the voltage measured by the measurement unit 45, ΔCx represents a sensing value of a touch, and the amplitude of the touch can be known from ΔCx.

Generally, when a finger touches the screen, since one finger may cover 2 to 3 sensing electrodes, the sensing value ΔCx of a touch is relatively large, so there is not much deviation for the data measured above. However, when a passive pen is used to touch, since the touch area between the passive pen and the sensing electrode is relatively small, the change ΔCx of the earth capacitor Cx of the sensing electrode caused by a touch is very small, and if equations (1) and (2) are quantized directly using the ADC without any process, only a very small part of quantization range of the ADC is used by equation (3), thereby causing the problem of inaccurate quantization and too large errors etc.

It can be seen from equations (1) and (2) that, the change range of ΔV45 can be changed by adjusting the values of K and Cb. Assumed that the measurement range of the ADC used for quantization is Vm˜Vh. Then for a small signal, the most ideal situation is that ΔV45 in equation (3) can cover all or most of the range of (Vh-Vm), thereby even a small change can be quantized into a very large difference, which is beneficial for improving the resolution precision of an analog quantity. The specific adjusting method is as follows:

At first, the values of Cb and K are adjusted to make V45 in equation (1) equal or close to Vm, the difference between V45 and Vm can be different depending on the difference of system application, meanwhile, the values of Cb and K are adjusted to make V45′ in equation (2) equal or close to Vh, the difference between V45′ and Vh can be different depending on the difference of system application. After such adjusting, ΔV45 in equation (3) can cover most of the range of (Vh-Vm), thereby the quantization precision is improved.

In actual applications, when a touch is detected, whether the touch object is a hand or a passive pen can be firstly determined, specifically, it is determined according to the number of the sensing electrodes covered by a touch or the characteristic of the touch object, and then different values of Cb and K are set for different touch objects, in order to achieve accurate detection for the touch positions of different touch objects.

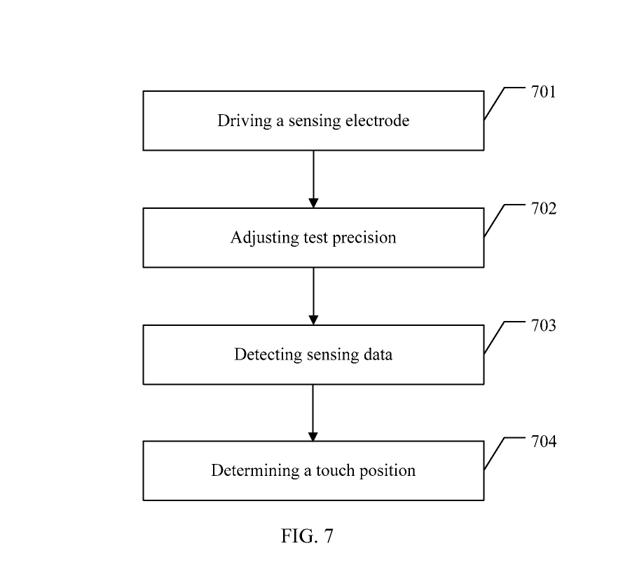

FIG. 7 shows a flow chart of a touch detection method according to an embodiment of the invention. When a touch occurs on a sensing electrode, the capacitance of the sensing electrode changes. This change is converted into a digital value by the ADC, then the touch information can be restored. Generally, the change of capacitance is related to the area of the sensing electrode covered by the touch.

As an example, in the following the detection method for a touch position is illustrated in detail.

701, driving a sensing electrode;

a sensing electrode provided on the substrate of a capacitive touch screen is driven by using a voltage source or current source;

702, adjusting a precision;

a precision for a sensing electrode is adjusted according to different touch objects by using an adjustable reference capacitor;

703, detecting sensing data;

a voltage or a frequency or an electricity quantity on the sensing electrode is detected according to the set precision;

704, determining a touch position.

The coordinates of a touch position of a finger can be obtained according to sensing data such as the voltage or frequency or electric quantity and other of the sensing electrode as well as the coordinates corresponding to the touched sensing electrode by using a centroid algorithm. For example, when there is a touch, the sensing electrodes 2a, 2b, 2c and 2d in FIG. 2 are covered by the finger, the corresponding sensing data are respectively PT1, PT2, PT3 and PT4, assumed that the horizontal coordinates is determined as x direction, the vertical coordinates is determined as y direction, and the coordinates corresponding to the sensing electrodes 2a-2d are respectively x1, x2, x3, x4. Then the coordinates of the touch position of a finger obtained by using the centroid algorithm is:

Xtouch=(PT1*x1+PT2*x2+PT3*x3+PT4*x4)/(PT1+PT2+PT3+PT4)

Here only a one-dimensional centroid algorithm is taken as an example, the actual coordinates is determined by a two-dimensional centroid algorithm.

In the embodiments, an adjustable reference capacitor is used to adjust a precision for the sensing electrode according to different touch objects, i.e. for different touch objects, different precisions are used to detect a voltage or a frequency or an electricity quantity on the sensing electrode, thereby achieving an accurate detection for a touch position.

The description of the embodiments herein enables those skilled in the art to implement or use embodiments of the invention. Numerous modifications to the embodiments will be apparent to those skilled in the art, and the general principle herein can be implemented in other embodiments without deviation from the spirit or scope of the present disclosure. Therefore, the scope of the disclosure will not be limited to the embodiments described herein, but in accordance with the widest scope consistent with the principle and novel features disclosed herein.

What is claimed is:

1. A capacitive touch screen, comprising:
a substrate;
a plurality of sensing electrodes provided on the substrate, the plurality of sensing electrodes being arranged in a two-dimensional array; and
a touch control chip bound to the substrate, the touch control chip being connected with each of the plurality of sensing electrodes via a corresponding wire, and the touch control chip being configured to detect a change of self-capacitance of each of the plurality of sensing electrodes by using a detection circuit with an adjustable precision, so as to determine touch information.

2. The capacitive touch screen according to claim 1, wherein the detection circuit with an adjustable precision comprises:
a voltage source or current source;
a capacitor to be detected, with one end of the capacitor to be detected being grounded, and the other end of the capacitor to be detected being connected with the voltage source or current source via a switch, wherein a capacitance of the capacitor to be detected changes when there is a touch;
an adjustable capacitor, the adjustable capacitor being connected with a voltage source or current source at its two ends, wherein the precision is adjusted by changing the capacitance value of the adjustable capacitor; and
a measurement unit, the measurement unit being connected to the adjustable capacitor and measuring the change of the self-capacitance of each of the plurality of sensing electrodes according to the precision.

3. The capacitive touch screen according to claim 2, wherein
the voltage source or current source has a single frequency; or
the voltage source or current source has two or more frequencies.

4. The capacitive touch screen according to claim 1, wherein the touch control chip detection of a change of self-capacitance of each of the plurality of sensing electrodes by using the detection circuit with an adjustable precision comprises:
detection of the changes of the self-capacitance of the plurality of sensing electrodes simultaneously by using the detection circuit with an adjustable precision; or
detection of the changes of the self-capacitance of the plurality of sensing electrodes group by group using the detection circuit with an adjustable precision.

5. The capacitive touch screen according to claim 1, wherein
the substrate is a glass substrate, and the touch control chip is bound to the substrate in a chip-on-glass way; or
the substrate is a flexible substrate, and the touch control chip is bound to the substrate in a chip-on-film way; or
the substrate is a printed circuit board, and the touch control chip is bound to the substrate in a chip-on-board way.

6. The capacitive touch screen according to claim 1, wherein the sensing electrode is in a shape of a rectangle, a diamond, a circle or an ellipse.

7. The capacitive touch screen according to claim 1, wherein the capacitive touch screen comprises a plurality of touch control chips bound to the substrate, and each touch control chip is adapted to detect a corresponding part of the plurality of sensing electrodes.

8. The capacitive touch screen according to claim 7, wherein the clocks of the plurality of touch control chips are synchronous or asynchronous.
